(19) United States
(12) Patent Application Publication
(10) Pub. No.: US 2004/0250863 A1
(43) Pub. Date: Dec. 16, 2004

(54) Backwater valve seat protector

(76) Inventors: Cliff Atkeson, Post Falls, ID (US); Kent L. Cossairt, Hayden, ID (US)

Correspondence Address: PEDERSEN & COMPANY, PLLC, P.O. BOX 2666, BOISE, ID, 83701, US

(21) Appl. No.: 10/837,252

(22) Filed: Apr. 30, 2004

Related U.S. Application Data
(60) Provisional application No. 60/467,760, filed on Apr. 30, 2003.

(51) Int. Cl. F16K 15/16

(52) U.S. Cl. 137/855

(57) ABSTRACT

A hard, durable valve seat or “valve seat protector” is provided in a plastic backwater valve with a flapper valve. The seating is more resistant to wear caused by cleaning, giving it a longer useful life despite the use of a less durable, less expensive plastic material for the rest of the valve and housing.

This application claims priority of Provisional Application Ser. No. 60/467,760, filed Apr. 30, 2003, and entitled “Backwater Valve Seat Protector,” which is hereby incorporated by reference.

### BACKGROUND OF THE INVENTION

1. Field of the Invention

This invention relates generally to backwater valves and more particularly to improvements in the durability of backwater valves.

2. Related Art

It is necessary to prevent the flow of sewage from sewage systems into the pipes that are meant to carry waste from buildings into the sewage system. This is accomplished by placing a one-way valve, known as a backwater valve, between the building and the sewage pipeline. Backwater valves often use a “flapper” that can be pushed out of the way by exiting fluids, but flips back down closing the valve whenever fluids attempt to flow back through the valve. The valve of Mitchell, et al. (U.S. Pat. No. 4,063,570) is a good example of this type of design. The surfaces that form the seal must be kept in good condition or they will fail to form a seal allowing backflow from the sewer line.

Plastic backwater valves were first used about thirty years ago. However, damage by common tools, such as a plumber's snake, has been a persistent problem with plastic backwater valves. Once the valve seat or “seating” is damaged, the valve will not function properly, allowing sewage to flow back through the valve during sewage backup conditions. This creates unacceptable health and sanitation problems. Nevertheless, despite the vulnerability of plastic valves to excessive wear, the economic advantages of plastics have justified the use of plastic valves over cast iron valves or other metal valves.

### SUMMARY OF THE INVENTION

The present invention comprises an improved valve seat for backwater valves. Further, the invention comprises a backwater valve constructed from relatively inexpensive plastic materials without a loss in durability due to the reinforcement of the valve seat with a more durable material. Thus, the invention improves the durability of plastic backwater valves without sacrificing their economic advantages.

The preferred embodiment comprises a plastic backwater valve with a hard, durable valve seating. The seating is resistant to wear caused by cleaning, giving the valve a longer useful life despite the use of a less durable, less expensive material for the rest of the valve and housing.

### BRIEF DESCRIPTION OF THE DRAWINGS

FIG. 1 is a cross-sectional side view of one embodiment of the invented backwater valve, with the valve closed.

FIG. 2 is a cross-sectional side view of the embodiment of FIG. 1 with the valve open.

FIG. 3 is a cut-away perspective view of a portion of the embodiment of FIG. 1, illustrating the inlet portion of the valve with the flapper valve removed to reveal one embodiment of the invented seat protector.

### DETAILED DESCRIPTION OF THE INVENTION

Referring to the figures, there is shown one, but not the only, embodiment of the invented backwater valve with one, but not the only, embodiment of the invented valve seat protector. The preferred backwater valve, including the valve housing and the flapper, is constructed from rigid plastic, with the preferred material being polyvinyl chloride (PVC), with a valve seat that is substantially harder and more durable than the valve housing and flapper. The valve seat may be made of any material, such as metals, ceramics, and some plastics, that are sufficiently hard to withstand wear from plumber's tools such as a plumber's snake, but the preferred material is stainless steel. The metal valve seat, for example, is resistant to wear, eliminating the need for the entire valve and housing to be constructed from metal or ceramic and eliminating much of the damage and leaking that often result from cleaning or unplugging of the valve.

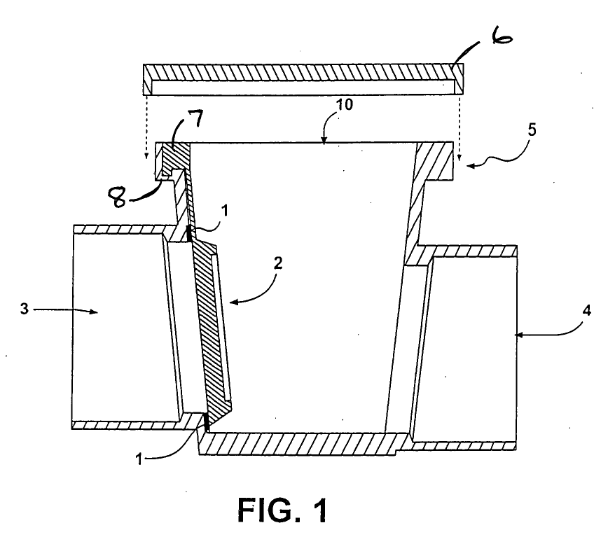

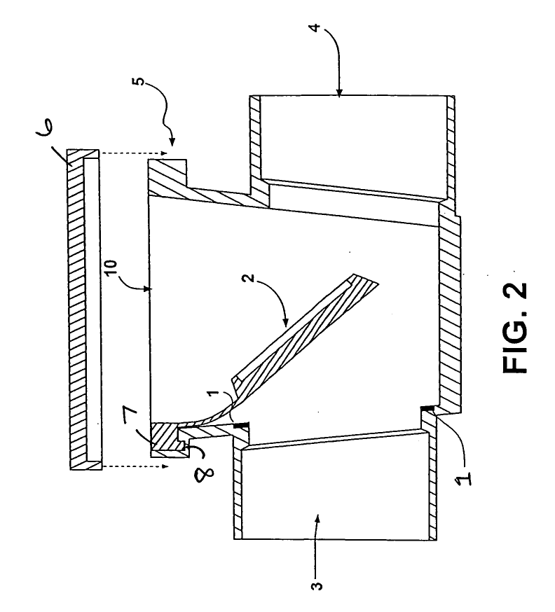

As shown in FIGS. 1 and 2, the preferred embodiment of the invention comprises a backwater valve with a plastic housing 5 with a circular inlet 3 and a circular outlet 4. The outlet 4 is typically positioned slightly lower than the inlet 3. The valve chamber 10 of the housing may be accessed by removing a cover 6 held in place by four screws. The valve housing may be made of any material resistant to corrosion and ordinary wear. The preferred material is PVC, but other materials such as acrylonitrile butadiene styrene resin (ABS) may be used.

Inside the valve chamber 10 is a backwater valve flapper or flap 2. The backwater valve flap 2 is forced to close whenever fluid pressure is greater on the outlet 4 side than on the inlet 3 side of the valve, as illustrated in FIG. 1, with the valve flap 2 contacting valve seating 1 to form a seal. When the fluid pressure on the inlet 3 side of the backwater valve flap 2 is greater than that on the outlet 4 side, the backwater valve flap 2 is pushed away from the valve seating 1, as shown in FIG. 2, allowing outflow of fluid. Various backwater valves may be used and will be understood by one of skill in this art after viewing this Description and the Drawings.

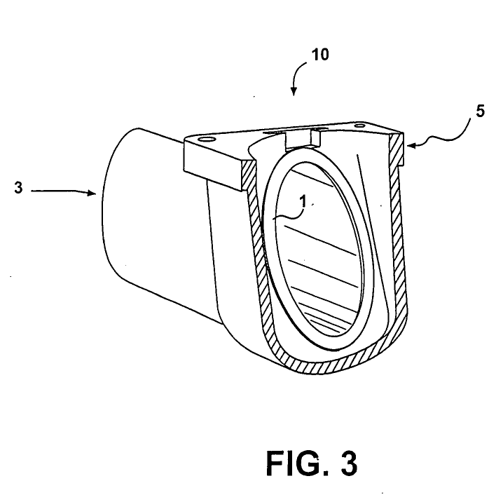

As shown in FIG. 3, the preferred invented valve seating 1 is a thin layer of metal, ceramic, or high durability plastic. The valve seating 1 may be made from any material that is resistant to wear and corrosion, with the preferred choice being stainless steel or another durable and corrosion-resistant metal. Other options include ferrous and non-ferrous metals such as plated steel or brass or ceramics. The seating also could be manufactured from a sufficiently durable plastic that is substantially more durable, and most likely more expensive, than the plastic used to manufacture the housing and flapper. Examples of such plastics include those generally with a Rockwell Hardness greater than about R120, and fiber reinforced plastics and reinforced plastic alloys. Although a high durability plastic would likely be too expensive to manufacture the entire valve and housing, using such a plastic for the valve seating alone could be economical. In the preferred embodiment, the valve seating 1 is a roughly circular flat ring approximately % inches wide. However, the valve seating 1 may be modified in shape and size to adapt to other backwater valves and housing shapes.

The preferred backwater valve flap 2 attaches to the valve housing by means of a tab 7 and slot 8 located at the top of the backwater valve flap 2. The receiving slot 8 is located just above the inlet 3 opening inside the valve chamber 10. The tab 7 is held in place by attaching the cover 6, which presses against the top of the backwater flap 2 at tab 7 when attached to the valve housing over the valve chamber 10, as illustrated in FIGS. 1 and 2. In the preferred embodiment, the cover 6 is held in place by four screws (not shown) inserted near the corners of the cover into the valve housing.

The valve seating 1 may be installed into the backwater valve by various means that will be known to one of skill in the plastics molding and valve arts, after viewing this Description and the Drawings. While the preferred valve seat will be installed in the valve during manufacture, the invention also includes embodiments in which the invented valve seat is added after manufacture of the valve by adding a thin valve seat protector or liner to protect/reinforce the existing plastic valve seat.

Although this invention has been described above with reference to particular means, materials, and embodiments, it is to be understood that the invention is not limited to these disclosed particulars, but extends instead to all equivalents within the scope of the following claims.

I claim:

1. In a backwater valve with a housing made of a first material with a first hardness, and having a flapper, the combination of said backwater valve with a valve seating for cooperating with the flapper wherein the valve seating is made of a second material with a second hardness that is greater than said first hardness.

2. The combination of claim 1, where said first material is selected from the group of polyvinyl chloride (PVC) and acrylonitrile butadiene styrene resin (ABS).

3. The combination of claim 1 where said second material is selected from the group of stainless steel, plated steel, brass, ceramic, and high durability plastics, including fiber reinforced plastics and reinforced plastic alloys.

4. The combination of claim 1 where said first material is polyvinyl chloride (PVC) and said second material is stainless steel.
